(19) United States
(12) Patent Application Publication
(10) Pub. No.: US 2021/0247057 A1
(43) Pub. Date: Aug. 12, 2021

(54) LIGHT HOLDER APPARATUS

(71) Applicant: Maribel Garza, Edinburg, TX (US)

(72) Inventor: Maribel Garza, Edinburg, TX (US)

(21) Appl. No.: 17/170,811

(22) Filed: Feb. 8, 2021

Related U.S. Application Data
(60) Provisional application No. 62/971,939, filed on Feb. 8, 2020.

(51) Int. Cl. F21V 21/088; F21S 4/10

(52) U.S. Cl. CPC F21V 21/088; F21W 2121/004; F21S 4/10

(57) ABSTRACT

A light holder apparatus includes a body member having a first side and an opposing second side and a recess configured to receive wiring of lighting; and an attachment arm member to extend from the body member, the attachment arm member movable between a first position and a second position, wherein the attachment arm member is configured to attach to an external feature when in the first position.

### BACKGROUND OF THE INVENTION

### 1. Field of the Invention

The present general inventive concept relates to light holder, and more particularly to a light holder configured to detachably attach to a building and removably support conventional lighting.

### 2. Description of Related Art

There have been previous devices developed to hold conventional lighting to various surfaces, including exterior surfaces of buildings. However, these devices are bulky and do not allow the lighting to be easily removed. Also, these devices require the use of inconvenient hooks and clips that need to removed each time the lighting is removed. Further, these conventional hooks and clips are aesthetically unpleasant and are therefore requires a significant more time for removal when not in use.

Therefore, what is desired is a light holding device that has an asthetically pleasant profile and allows conventional lighting to be easily removed from various internal and external surfaces of buildings.

### SUMMARY OF THE INVENTION

The present general inventive concept relates to a light holder configured to detachably attach to buildings and removably support conventional lighting.

That present general inventive concept also relates to a light holder apparatus designed as a low-cost, thin, customizable, and permanent light holding device that securely holds conventional lighting against either an exterior trim or gutters of a house and allows the lighting to be easily removed.

The present general inventive concept also relates to a light holding device that includes a central flap or slit that allows users to easily insert wiring of conventional lighting to support the conventional lighting and also to remove the conventional lighting, without requiring the user to climb a ladder.

Features and aspects of the present inventive provide a light holder apparatus including a body member having a first side and an opposing second side and a recess configured to receive wiring of lighting, and an attachment arm member to extend from the body member, the attachment arm member movable between a first position and a second position, wherein the attachment arm member is configured to attach to an external feature when in the first position.

The body member may include one or more attachment protrusions.

The attachment arm member may include one or more arm protrusions configured to be detachably coupled to the one or more attachment protrusions on the body member.

The body member may have a cross-section in a C-shape.

The body member may include a relief portion configured to assist a movement of the attachment arm member.

The body member may have a user-definable length.

The body member may be flexible.

The body member may be rollable onto a spool.

The body member may include a longitudinal slit to provide access to the recess from an external environment.

The body member may include a plurality of drainage openings or through holes.

The light holder apparatus of claim 1, wherein the first side of the body member includes a plurality of holes through which fasteners are inserted.

Features and aspects of the present inventive also provide a method of a light holder apparatus including attaching a light holder apparatus to a structure, wherein the light holder apparatus has a cross-section in a C-shape, wherein the C-shaped cross-section of the light holder apparatus has a front, a back, a top, and a bottom, wherein the front of the C-shaped cross-section of the light holder has an opening configured to receive lights, wherein the back of the top of the C-shaped cross-section of the conduit has a flat surface extending backwards from the back of the C-shaped cross-section of the light holder apparatus, wherein the flat surface has a hooked end and wherein the bottom of the back of the C-shaped cross-section of the light holder apparatus has a recess.

The light holder apparatus may have a user-definable length.

The light holder apparatus may be flexible.

The light holder apparatus may be rollable onto a spool.

The front of the C-shaped cross-section of the light holder apparatus may have a longitudinal slit to receive wiring of a conventional light.

The conventional lights may include a string of lights. However, the present general inventive concept is not limited thereto.

Additional aspects of the present general inventive concept will be set forth in part in the description which follows and, in part, will be obvious from the description, or may be learned by practice of the general inventive concept.

### BRIEF DESCRIPTIONS OF THE DRAWINGS

These and/or other aspects of the present general inventive concept will become apparent and more readily appreciated from the following description of the embodiments, taken in conjunction with the accompanying drawings of which:

FIG. 1 is a front perspective view a light holder apparatus according to an embodiment of the present inventive concept;

FIG. 2A illustrates a front view of the light holder apparatus illustrated in FIG. 1, in a first assembly state;

FIG. 2B illustrates a front view of the light holder apparatus illustrated in FIG. 1, in a second assembly state;

FIG. 3 is a front view of the light holder apparatus illustrated in FIG. 2B, assembled with conventional lighting;

FIG. 4A is a side view of the light holder apparatus illustrated in FIG. 2A, assembled onto a conventional gutter;

FIG. 4B is a side view of the light holder apparatus illustrated in FIG. 2B, assembled onto conventional framing;

FIG. 5 is a front perspective view a light holder apparatus according to another embodiment of the present inventive concept, in a first assembly state;

FIG. 6 illustrates a front view of the light holder apparatus illustrated in FIG. 5;

FIG. 7 illustrates a side view of the light holder apparatus illustrated in FIG. 6, assembled onto a conventional gutter with conventional lighting installed;

FIG. 8 is a front perspective view the light holder apparatus illustrated in FIG. 5, in a second assembly state;

FIG. 9 illustrates a front view of the light holder apparatus illustrated in FIG. 8;

FIG. 10 illustrates a side view of the light holder apparatus illustrated in FIG. 9, assembled with conventional lighting;

FIG. 11 is a front perspective view a light holder apparatus according to another embodiment of the present inventive concept;

FIG. 12A illustrates a front view of the light holder apparatus illustrated in FIG. 11;

FIG. 12B illustrate an enlarged view of detail A in FIG. 12A; and

FIG. 13 illustrates a side view of the light holder apparatus illustrated in FIG. 11 assembled with conventional lighting.

### DESCRIPTION OF INVENTION

Reference will now be made in detail to the exemplary embodiments of the present general inventive concept, examples of which are illustrated in the accompanying drawings, wherein like reference numerals refer to the like elements throughout. The exemplary embodiments are described below in order to explain the present general inventive concept by referring to the figures.

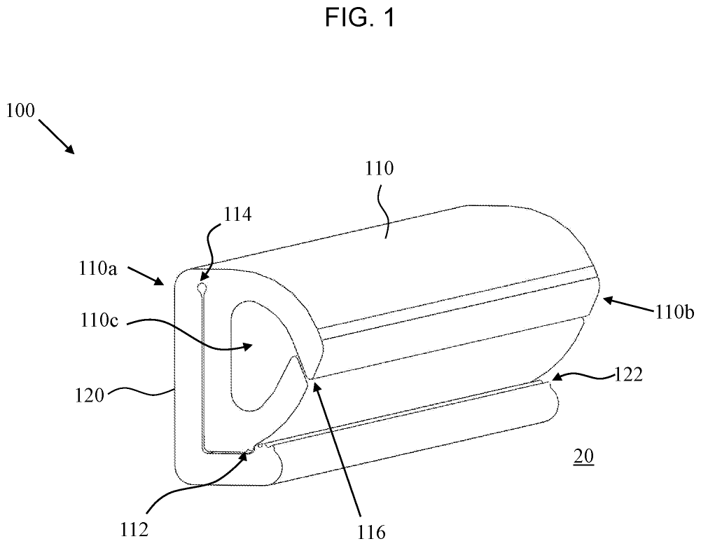

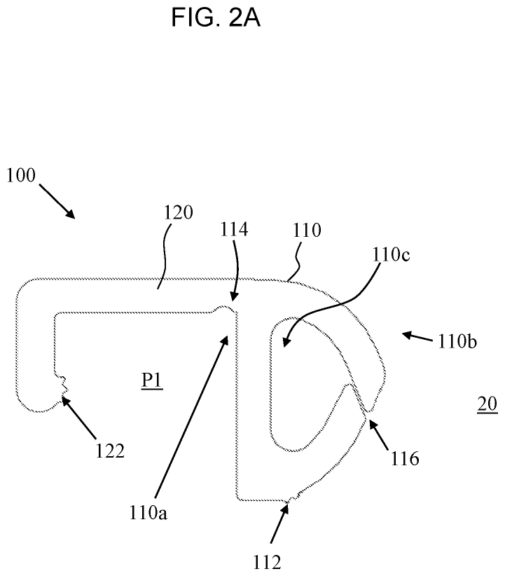

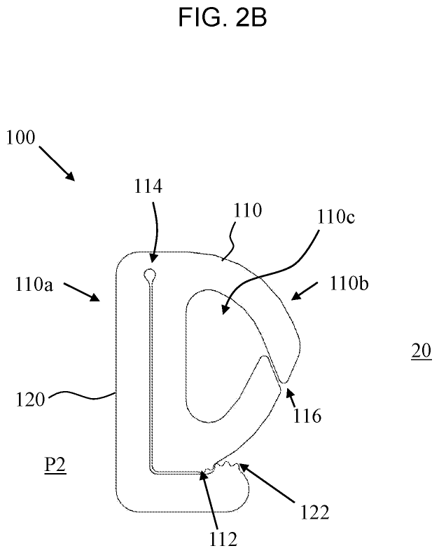

FIG. 1 is a front perspective view a light holder apparatus 100 according to an embodiment of the present inventive concept, FIG. 2A illustrates a front view of the light holder apparatus 100 illustrated in FIG. 1, in a first assembly state (i.e., a first position), and FIG. 2B illustrates a front view of the light holder apparatus 100 illustrated in FIG. 1, in a second assembly state (i.e., a second position).

According to an example embodiment of the present general inventive concept, the light holder apparatus, designated generally as 100, is designed and configured to removably mount conventional lighting to various building surfaces, including conventional rain gutters, building framing, and interior frames. However, the present general inventive concept is not limited thereto.

Referring to FIGS. 1 through 2B, in an example embodiment, the light holder apparatus 100 includes a body member 110 having a first side 110a and an opposing second side 110b, and an attachment arm member 120 extending from the first side 110a that is configured to move between a first position P1 (see FIG. 2A) and a second position P2 (see FIG. 2B).

In the present embodiment, the body member 110 includes a longitudinal slit 116 configured to provide access into the recess 110c from an external environment 20.

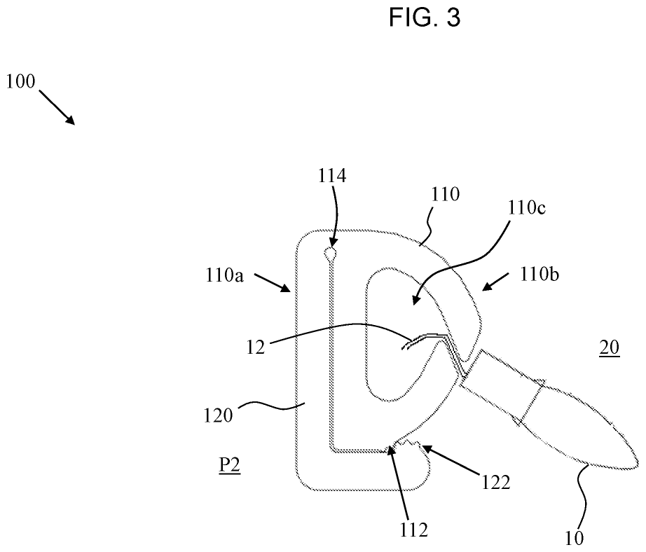

FIG. 3 is a front view of the light holder apparatus 100 illustrated in FIG. 2B, assembled with conventional lighting 10.

Referring to FIG. 3, in the present embodiment, the body member 110 includes a recess 110c that is configured to receive wiring 12 of the conventional lighting 10. The attachment arm member 120 extends from the first side 110a of the body member 110 and is configured to attach to an external feature, when the attachment arm member 120 is moved to the first position P1.

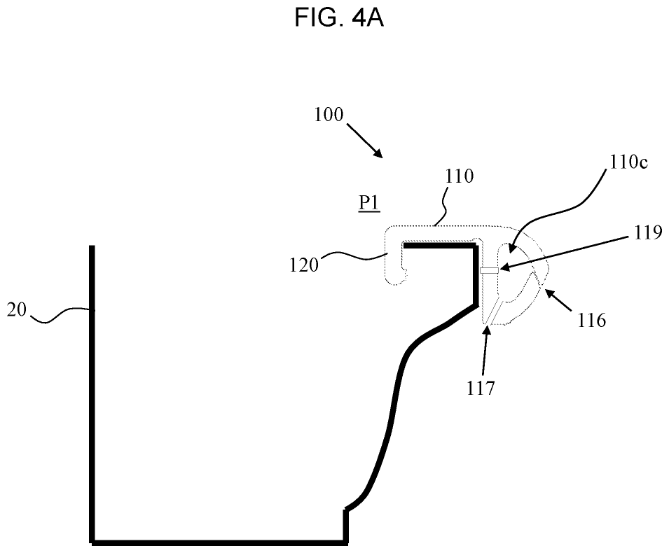

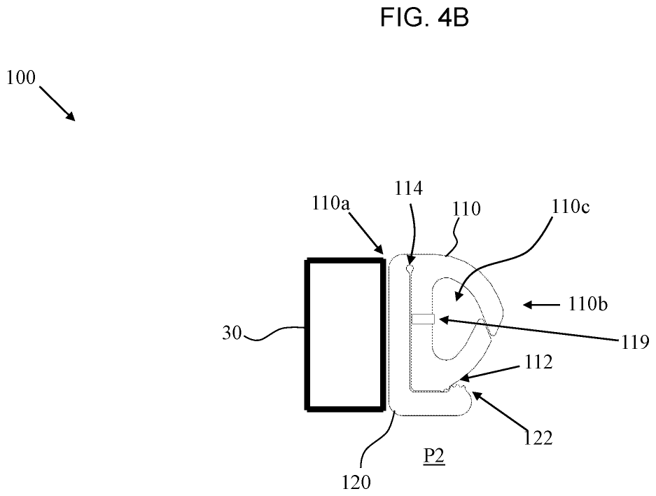

FIG. 4A is a side view of the light holder apparatus 100 illustrated in FIG. 2A, assembled onto a conventional gutter 20 and FIG. 4B is a side view of the light holder apparatus 100 illustrated in FIG. 2B, assembled onto conventional framing 30.

Referring to FIG. 4A, in exemplary embodiments, the external feature may include conventional rain gutters, roofing material, housing trim, facia board, interior or exterior framing or various other items attached to an interior or exterior of a building. However, the present general inventive concept is not limited thereto.

In exemplary embodiments, the attachment arm member 120 may be formed in various shapes, including a hook or L-shape. However, the present general inventive concept is not limited thereto.

In alternative embodiments, the body member 110 includes one or more attachment protrusions 112 and the attachment arm member 120 includes one or more protrusions 122 that are configured to be detachably coupled to the one or more attachment protrusions 112 of the body member 110.

In alternative embodiments, the body member 110 has a cross-section in a C-shape. However, the present general inventive concept is not limited thereto. That is, the body member 110 may be formed in various shapes and sizes, as desired.

In alternative embodiments, the body member 110 includes a relief portion 114 that is configured to assist a movement of the attachment arm member 120 from the first position P1 to the second position P2. That is, the relief portion 114 is designed to allow the attachment arm member 120 to easily move between the first and second positions P1, P2.

In the present embodiment, the light holder apparatus 100 may be formed in various lengths and materials, as desired by a user. In exemplary embodiments, the light holder apparatus 100 may be formed in a user-definable lengths from about 5 feet to about 100 feet and formed of a flexible or semi-flexible material so as to be rollable onto a spool. However, the present general inventive concept is not limited thereto.

FIG. 3 is a front view of the light holder apparatus 100 illustrated in FIG. 2B, assembled with conventional lighting 10, FIG. 4A is a side view of the light holder apparatus 100 illustrated in FIG. 2A, assembled onto a conventional gutter 20, and FIG. 4B is a side view of the light holder apparatus 100 illustrated in FIG. 2B, assembled onto conventional framing 30.

According to an exemplary embodiment, referring to FIG. 3, a conventional lighting 10 may be installed onto the light holder apparatus 100 by inserting wiring 12 of the conventional lighting 10 into the recess 110c of the body member 110 through the longitudinal slit 116.

Referring to FIG. 4A, in the present embodiment, the light holder apparatus 100 installed with the conventional lighting 10 may be assembled onto a conventional rain gutter 20, when the attachment arm member 120 is moved to the first position P1.

Referring to FIG. 4B, in the present embodiment, the light holder apparatus 100 may be assembled onto conventional framing 30, when the attachment arm member 120 is moved to the second position P2.

In alternative embodiments, the body member 110 includes a plurality of drainage openings 117 configured to drain fluid accumulated in the recess 110c.

In yet further alternative embodiments, the first side 110a of the body member 110 includes a plurality of holes 119 through which fasteners are inserted to attach the light holder apparatus 100 to various external features, including conventional rain gutters, roofing material, housing trim, facia board, interior or exterior framing or various other items attached to an interior or exterior of a building. However, the present general inventive concept is not limited thereto.

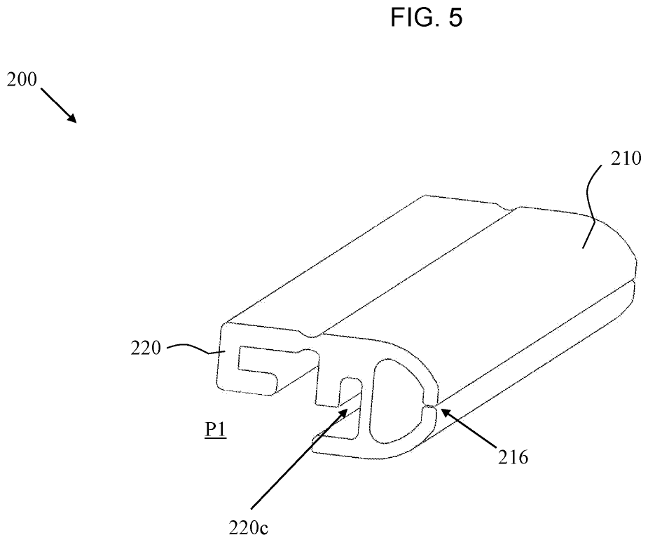

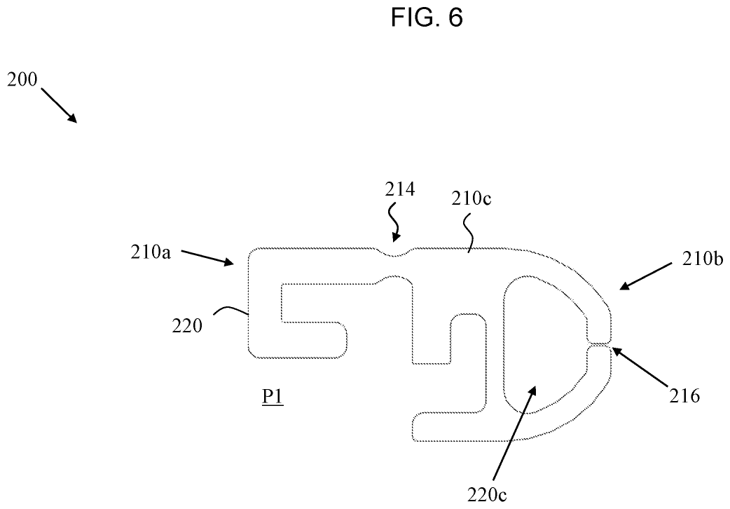

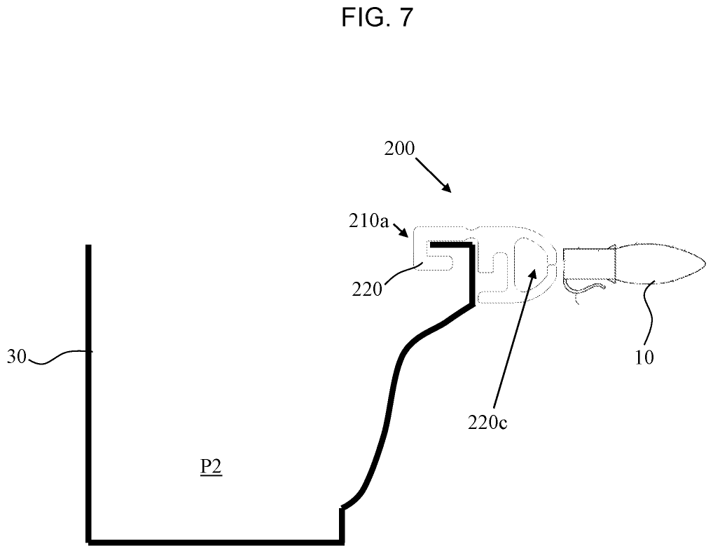

FIG. 5 is a front perspective view a light holder apparatus 200 according to another embodiment of the present inventive concept, in a first assembly state A1, FIG. 6 illustrates a front view of the light holder apparatus 200 illustrated in FIG. 5, and FIG. 7 illustrates a side view of the light holder apparatus 200 illustrated in FIG. 6, assembled onto a conventional gutter 20 with conventional lighting 10 installed.

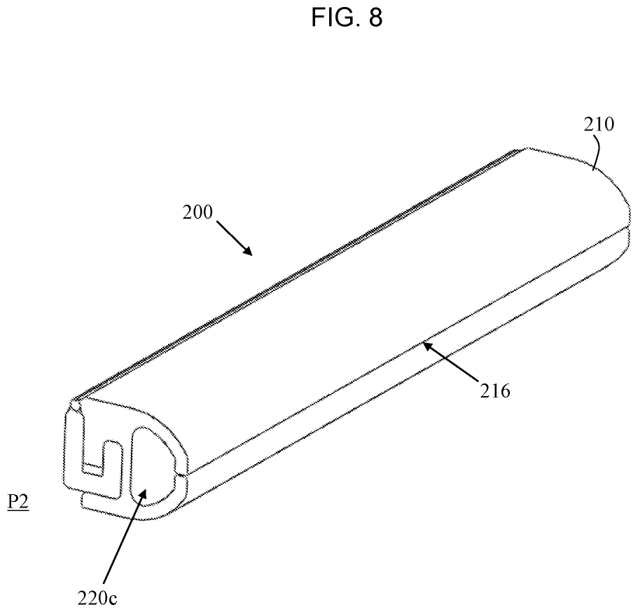

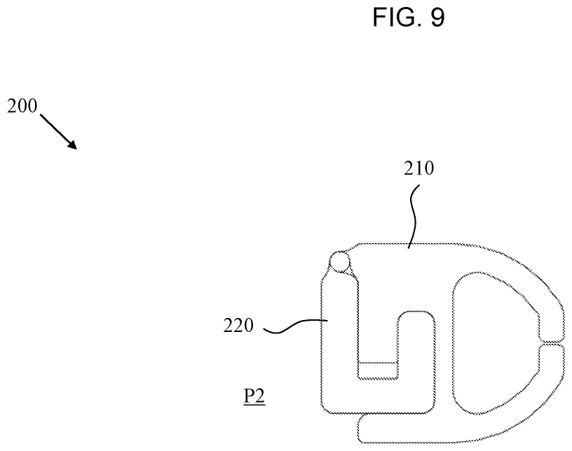

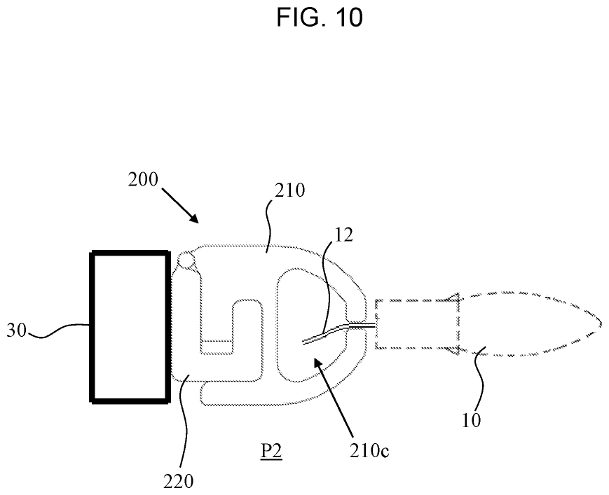

FIG. 8 is a front perspective view the light holder apparatus illustrated in FIG. 5, in a second assembly state, FIG. 9 illustrates a front view of the light holder apparatus illustrated in FIG. 8, and FIG. 10 illustrates a side view of the light holder apparatus illustrated in FIG. 9, assembled with conventional lighting.

Referring to FIGS. 5 through 7, the light holder apparatus, designated generally as 200, is illustrated. In the present embodiment, the light holder apparatus 200 is designed and configured for removably mounting conventional lighting to various building surfaces, including conventional rain gutters, building framing, and interior door frames. However, the present general inventive concept is not limited thereto.

In the present embodiment, the light holder apparatus 200 includes a body member 210 having a first side 210a and an opposing second side 210b, and an attachment arm member 220 extending from the first side 210a that is configured to move between a first position P1 and a second position P2.

In the present embodiment, the body member 210 includes a recess 210c that is configured to receive wiring 12 of conventional lighting 10. The attachment arm member 220 extends from the first side 210a of the body member 210 and is configured to attach to an external feature, when moved in the first position P1.

In the present embodiment, the body member 210 further includes an arm recess 220c designed and configured to receive and hold the attachment arm member 220, when moved to the second position P2 to be assembled onto a flat surface including conventional framing 20.

The external feature 10 may include an edge of conventional rain gutters, roofing material, housing trim, facia board, or various other items attached to an interior or exterior of a building. However, the present general inventive concept is not limited thereto.

In exemplary embodiments, the attachment arm member 220 may be formed in various shapes, including a hook or L-shape. However, the present general inventive concept is not limited thereto.

In alternative embodiments, the body member 210 has a cross-section in a C-shape. However, the present general inventive concept is not limited thereto.

In alternative embodiments, the body member 210 includes a relief portion 214 that is configured to assist a movement of the attachment arm member 220 from the first position P1 to the second position P2.

In the present embodiment, the light holder apparatus 200 may be formed in various lengths as desired by a user. In exemplary embodiments, the light holder apparatus 200 may be formed in a user-definable lengths from about 5 feet to about 100 feet. The body member 210 may be formed of a flexible or semi-flexible material so as to be rollable onto a spool. However, the present general inventive concept is not limited thereto.

In the present embodiment, the body member 210 includes a longitudinal slit 216 configured to provide access into the recess 210c from an external environment 20.

In alternative embodiments, the body member 210 includes a plurality of drainage openings configured to drain fluid accumulated in the recess 210c.

In yet further alternative embodiments, the first side 210a of the body member 210 includes a plurality of holes through which fasteners are inserted.

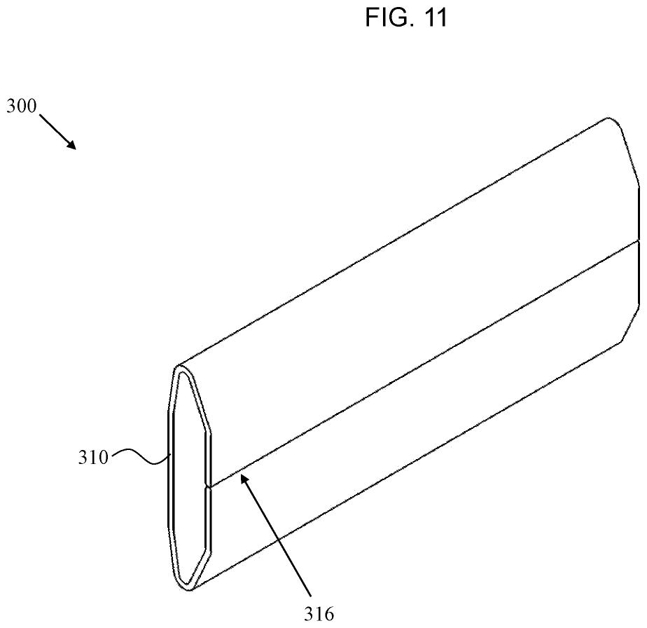

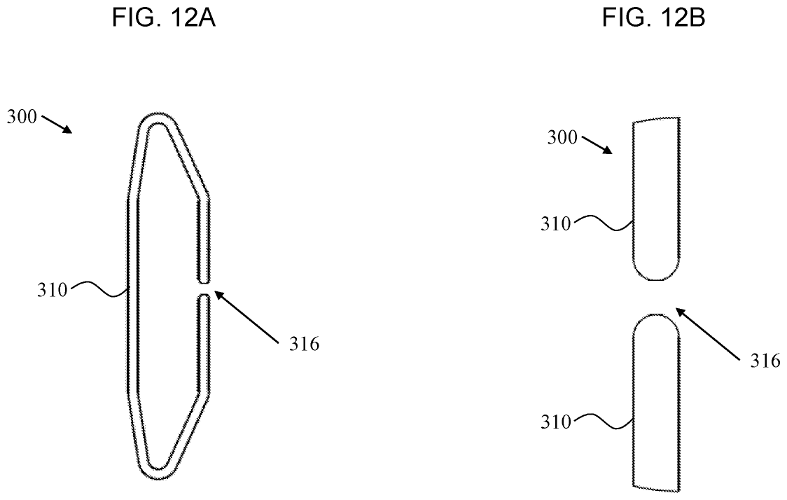

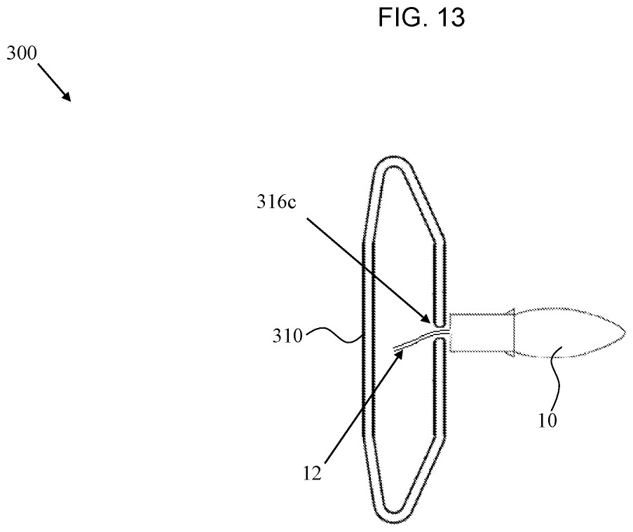

FIG. 11 is a front perspective view of a light holder apparatus 300 according to another embodiment of the present inventive concept, FIG. 12A is a front view of the light holder apparatus 300 illustrated in FIG. 11, and FIG. 12B is an enlarged view of detail A in FIG. 12A. FIG. 13 is a cross-section view of the light holder apparatus 300 illustrated in FIG. 11 assembled with a conventional lighting.

Referring to FIGS. 11 through 13, the light holder apparatus 300, designated generally as 300, is illustrated. In the present embodiment, the light holder apparatus 300 is designed and configured as a device that has a low-profile and allows the lighting to be easily removed.

In the present embodiment, the light holder apparatus 300 includes a low-profile strip having a C-shaped cross section and at least one flat surface. The flat surface is placed against an exterior house trim or interior walls and the wiring 12 of the lighting 10 may be inserted within the light holder apparatus 300 through the cutout/slit portion 316. However, the present general inventive concept is not limited thereto.

In alternative embodiments, the light holding strip apparatus 300 is designed to be a permanent decorative light holder that may be attached to the exterior (or interior) trim of a house. The light holding strip apparatus 300 may be manufactured and delivered as a spooled up roll that can be customized to any desired size by cutting, The light holding strip apparatus 300 has a body member 310 having a central flap or cut 316 disposed along the longitudinal length in which the wiring of the decorative lights 10 is inserted into. The light holding strip apparatus 300 includes a flat surface through which a screw or nail may be used to affix the light holding strip apparatus 300 to any desired surface, interior or exterior of a house. The cut 316 allows a user to easily remove the conventional lighting from any angle, including remaining on the ground when the light holding strip apparatus 300 is attached to a roof line of a house or building.

That is, in alternate embodiments, the light holding strip apparatus 300 may further include hooks integrally formed with the flat surface that are designed to be removable attached to gutters or fences. However, the present inventive concept is not limited thereto.

In the present embodiment, the light holding strip apparatus 300 may further include vent holes formed to allow water and moisture to escape from within the C-shaped light holding strip apparatus 300.

Although a few exemplary embodiments of the present general inventive concept have been illustrated and described, it will be appreciated by those skilled in the art that changes may be made in these exemplary embodiments without departing from the principles and spirit of the general inventive concept, the scope of which is defined in the appended claims and their equivalents.

What is claimed is:

1. A light holder apparatus comprising:
a body member having a first side and an opposing second side and a recess configured to receive wiring of lighting; and
an attachment arm member to extend from the body member, the attachment arm member movable between a first position and a second position,
wherein the attachment arm member is configured to attach to an external feature when in the first position.

2. The light holder light apparatus of claim 1, wherein the body member includes one or more attachment protrusions.

3. The light holder apparatus of claim 2, wherein the attachment arm member includes one or more arm protrusions configured to be detachably coupled to the one or more attachment protrusions.

4. The light holder apparatus of claim 1, wherein the body member has a cross-section in a C-shape.

5. The light holder apparatus of claim 1, wherein the body member includes a relief portion configured to assist a movement of the attachment arm member.

6. The light holder apparatus of claim 1, wherein the body member has a user-definable length.

7. The light holder apparatus of claim 1, wherein the body member is flexible.

8. The light holder apparatus of claim 1, wherein the body member is rollable onto a spool.

9. The light holder apparatus of claim 1, wherein the body member includes a longitudinal slit to provide access to the recess from an external environment.

10. The light holder apparatus of claim 1, wherein the body member includes a plurality of drainage openings.

11. The light holder apparatus of claim 1, wherein the first side of the body member includes a plurality of holes through which fasteners are inserted.

12. A method of a light holder apparatus, comprising:
attaching a light holder apparatus to a structure;
wherein the light holder apparatus has a cross-section in a C-shape;
wherein the C-shaped cross-section of the light holder apparatus has a front, a back, a top, and a bottom;
wherein the front of the C-shaped cross-section of the light holder has an opening configured to receive lights;
wherein the back of the top of the C-shaped cross-section of the light holder apparatus has a flat surface extending backwards from the back of the C-shaped cross-section of the light holder apparatus;
wherein the flat surface has a hooked end; and
wherein the bottom of the back of the C-shaped cross-section of the light holder apparatus has a recess.

13. The method of claim 12, wherein the light holder apparatus has a user-definable length.

14. The method of claim 12, wherein the light holder apparatus is flexible.

15. The method of claim 14, wherein the light holder apparatus is rollable onto a spool.

16. The method of claim 12, wherein the front of the C-shaped cross-section of the conduit has a longitudinal slit.

17. The method of claim 12, wherein the lights are a string of lights.
